(19) United States
(12) Patent Application Publication
(10) Pub. No.: US 2007/0044724 A1
(43) Pub. Date: Mar. 1, 2007

(54) Sequentially operable modular animal feeder

(76) Inventor: Kevin Kvols, Colorado Springs, CO (US)

Correspondence Address: HANES & SCHUTZ, LLC, 102 SOUTH TEJON ST., SUITE 800, COLORADO SPRINGS, CO, 80903, US

(21) Appl. No.: 11/209,392

(22) Filed: Aug. 24, 2005

(51) Int. Cl. A01K 61/02

(52) U.S. Cl. 119/56.1; 119/57.1

(57) ABSTRACT

An animal feeder comprising a feed serving trough having frontal animal access and a feed delivery chute with an openable trough door, a plurality of feed storage modules stacked on the trough and over the trough door, the feed modules having an openable top comprising double trap doors, a latch for maintaining the trough door and each respective one of the traps doors closed and a linear actuator operatively connected to each of the latches for causing the latches to release the trough door and the trap doors of the respective feed boxes in a timed sequence.

### FIELD OF THE INVENTION

The present invention relates to an automated animal feeding apparatus that operates to sequentially serve multiple feedings.

### BACKGROUND OF THE INVENTION

The need for an automated animal feeding device that will dispense a single one of many available servings of animal food at predetermined times has long been recognized. Providing such a device allows the animal owner to load several days of food into the apparatus and know that in the owner's absence one meal at a time will be dispensed at predetermined intervals.

Typical of such devices is the automated livestock feeder for storing and dispensing food disclosed in U.S. Pat. No. 6,779,487. While continuing the concept of stacking a plurality of single serving feed containing modules, the primary object of the present invention is to provide a food release mechanism that is unlike the one disclosed in the '487 patent in that will not continue to narrow the food delivery chute as additional feed modules are activated to dispense their content.

Another object of the present invention is to provide a simple and efficient latching mechanism for the openable floor of each of the stacked food retaining boxes.

A further object of the invention is to provide a semi-confined trough into which feed from the storage modules is dispensed, where the trough also serves as a standing base so that the feeder may be placed on the ground or on a floor.

A still further object of the invention is to provide a releasable latching mechanism for the feed supporting trap doors that can be easily re-latched by the mere act of manually repositioning the trap doors into their closed position.

Other and further objects, features and advantages of the present invention will become apparent upon a reading of the following description of the invention, taken in conjunction with the accompanying drawings.

### SUMMARY OF THE INVENTION

The animal feeder of the present invention comprises a plurality of rectangular shaped boxes, each comprising a feed retaining module. The modules are vertically stacked above a feed dispensing trough having a frontal opening that allows an animal to reach food that has dropped into the trough from the surmounted feed modules. The top of the trough and the top of each feed box comprise a pair of opposed trap doors that, when held closed with a latching mechanism, form a floor for the module mounted immediately above it. When the doors are opened by an actuator coupled to the latching mechanism, the feed that is stored in the module for which the trap doors form a floor falls out of the module and down into the trough. In operation the trap doors beneath the bottommost feed box are programmed to open first. Until manually closed all of the trap doors remain open to allow feed from the higher modules to reach the trough as the respective trap doors on the higher boxes are sequentially opened starting with the trap door on the top of the feed trough and progressing upwardly to the trap doors that form the floor of highest feed containing module. The opening of each of the trap doors is controlled by a predetermined program that operates a linear actuator connected to a rod and catch combination. When triggered, the actuator causes the trap door retaining rods to release the door or doors from their closed position and dispense the food in the next highest contiguous feed box into the trough. The timing and programming apparatus, valves, compressor and other hardware associated with the release of the latching mechanism for the trap doors are contained in a separate module on the top of the stack. The preferred form of the invention employs air cylinders as the actuating means for the latching mechanism. Air conveying hoses are deployed along one side of the module stack to convey air pressure from the compressor in a tray above the top module to the individual actuators mounted in connected with each set of trap doors. Although compressed air is the preferred means of unlatching the trap doors, electric solenoids could alternatively be used.

### DESCRIPTION OF THE DRAWINGS

FIG. 1 is a frontal perspective view of the animal feeder of the present invention shown resting on the ground.

FIG. 2 is a cross sectional view taken along lines 2-2 in FIG. 1.

FIG. 3 is a cross sectional view taken along lines 3-3 in FIG. 2.

FIG. 4 is a fragmentary cross sectional view of lowermost feed containing module taken along lines 4-4 of FIG. 3 and illustrating the ceiling trap doors in their closed position.

FIG. 5 is a fragmentary cross section view similar to that of FIG. 4, but showing the trap doors in a descending position and being half open.

### DETAILED DESCRIPTION OF PREFERRED EMBODIMENT

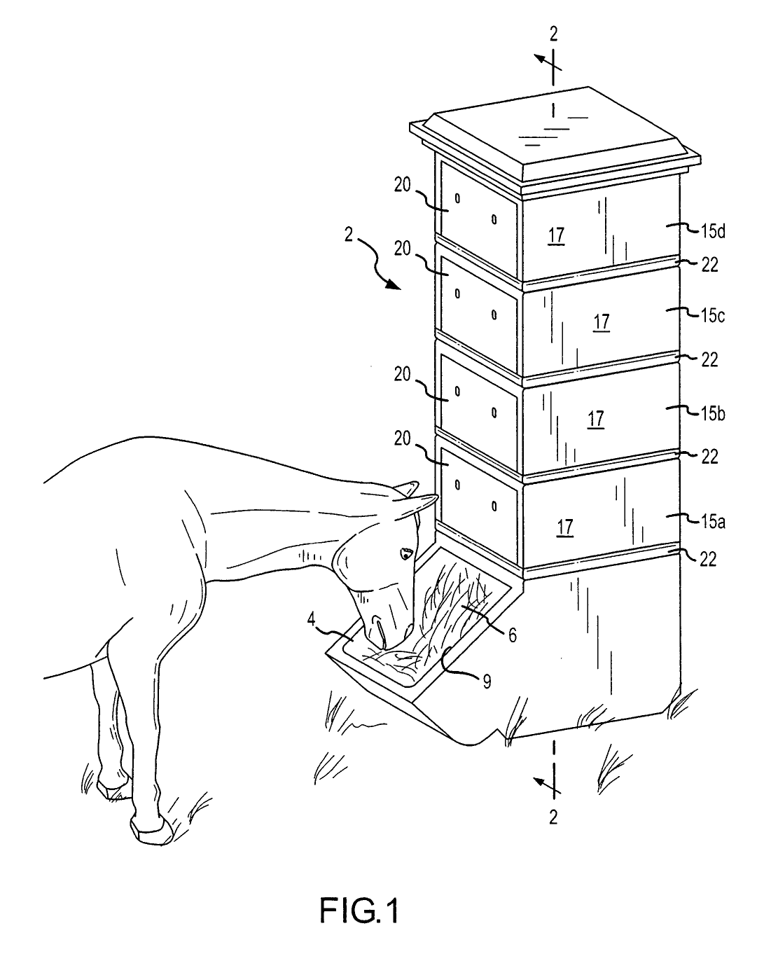

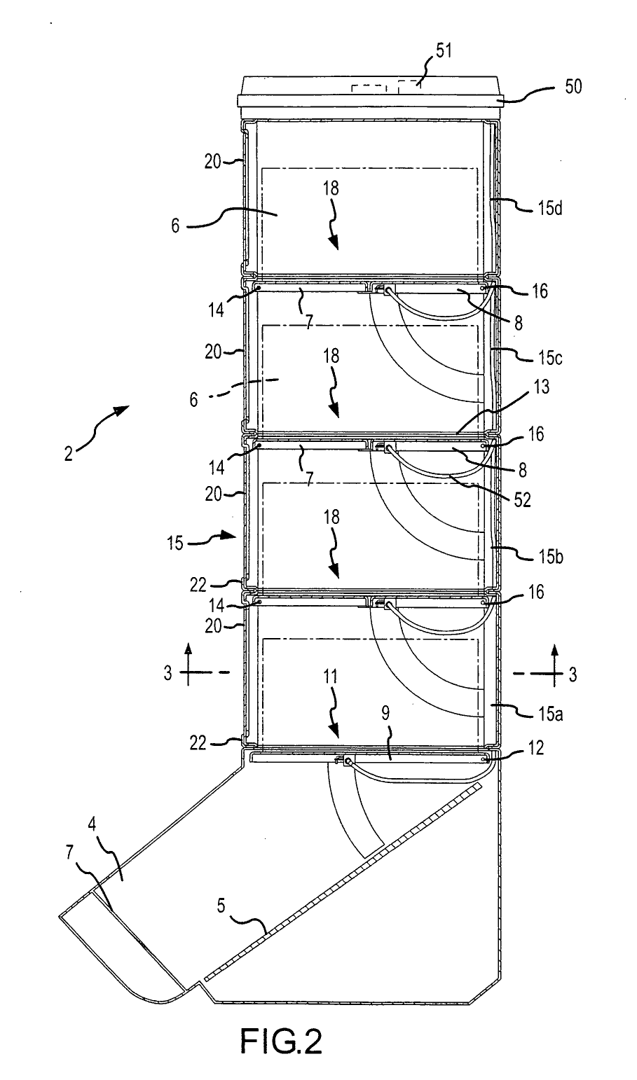

FIG. 1 illustrates an animal feeder 2 of the present invention having four separate feed retaining modules or boxes 15a-15d surmounted over the top entry opening of a feed trough 4. The feed trough acts as a base for the feeder and may be placed on a floor or on the ground. Alternatively the entire feeder 2 may be hung from a stock panel or wall. As shown in FIG. 2, the trough is the bottom component of the feeder and comprises a chute having an inclined floor surface 5 with an angularly oriented end portion 7 that functions to retain, within the trough, the pellet food, grain or hay 6 that is dispensed into the trough from the feed retaining modules mounted above the trough. An opening in the top of the trough allows an animal access to the food that has been dispensed onto the floor 5 of the trough. An opening 11 above the inclined floor surface 5 permits food to enter the trough from the feed storage modules 15a-15d that are vertically stacked above the opening 11. Although a plurality of feed storage boxes are shown, the invention can function and be useful with only one feed box, that is, the box immediately above the trough.

Each of the feed retaining modules is sized and dimensioned to hold enough animal feed for a single meal or feeding. Depending on the animal to be fed, the boxes may contain pellets, grain, hay or other suitable food 6. Except for the absence of ceiling trap doors on the topmost feed storage module 15d in the stack, all of the feed storage boxes are similarly constructed. They are designed to be superimposed, one upon the other, with the lowest box 15a surmounted on the trough 4 over its upper opening 11.

Each feed retaining box is rectangular in plan view and comprises rigid side members 17, an open bottom 18 and operable trap doors 7 and 8 that make up the top or ceiling of the box. The stacking of the modules permits the openable top of one box to function as the floor of the box mounted immediately above it. The openable floor in the bottommost feed retaining module 15a is formed by a single trap door 9. The trap door 9 is hinged to and hung from the sides of the trough 4 by pivot pins 12. In its open position the trap door 9 lies against the trough floor 5.

Each side member of each box is provided along its top and bottom edges with flanges 22 that abut similar flanges on an adjoining box, or the edges of the trough opening 11, to establish a mounting frame for the module above it. Threaded securing studs with nuts interconnect the flanges and hold the modules 15 in place within the feeder structure 2.

All of the side members are fixed, as part of the box structure, except one. That one side is provided with a latchable door 20 that allows the box to be opened and charged with food. Depending on where the feeder 2 is positioned with respect to walls, fences, panels or similar obstructions, the feed charging doors 20 on the modules may be disposed so as to face the front or either of the sides of the feeder 4. This selectivity is implemented by the rectangular shape of the boxes and by the symmetry of the connections between the upper edge flanges 22 of the trough and the securing studs protruding through the lower edge flanges 22 of the lowermost module 15a. With such symmetry the whole stack may be rotated to one of three facing positions by selectively placing the lowest box 15a into the retaining flanges 22 of the trough 4 so that the feed charging doors 20 of the boxes are either facing forward or facing toward one of the sides of the feeder. The feed charging doors 20 of the boxes above the lowermost box are all oriented to face the same way as the door on the lowermost box.

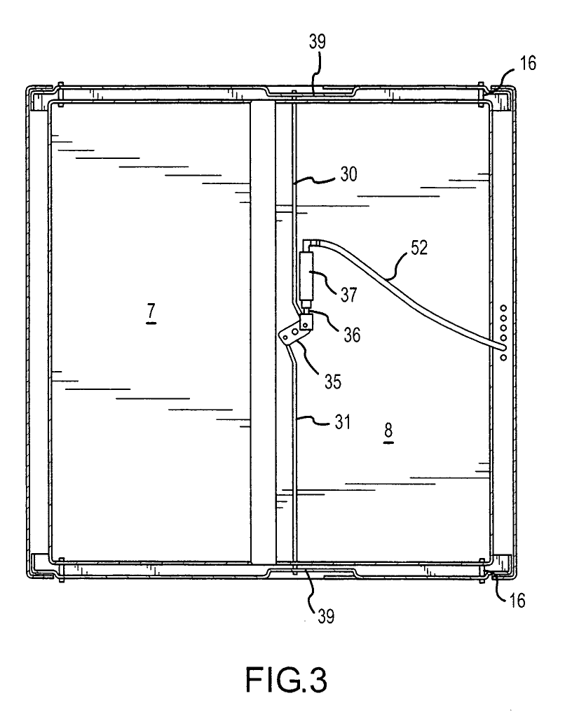

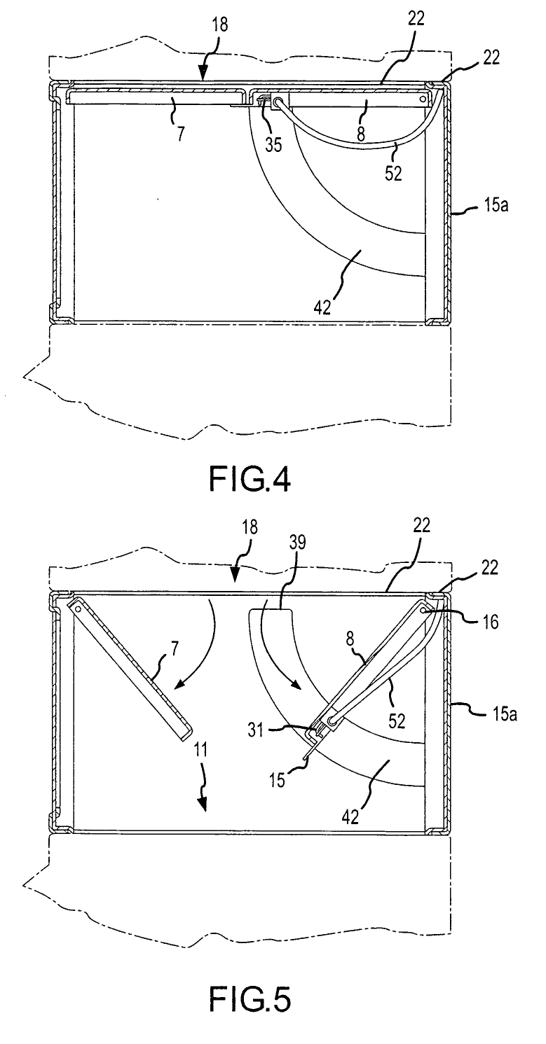

The construction and operation of the trap door 9 at the top entry opening 11 of the trough and the trap doors 7 and 8 on each feed retaining box 15a-15c is shown in FIGS. 3 through 5. With respect to the trap doors carried by the feed module boxes, the activating trap door 8 contains a flat floor surface 13 having a depending forward edge lip 15. The door 8 is pivotally hung by pivot pins 16 carried by opposing sides of the box that carries the trap doors. An idler trap door 7 includes a floor surface coplanar with the floor surface 13 of the activating trap door and is hung from opposing sides of the box with pivot pins 14. The forward longitudinal edge of the idler trap door 7 is supported in its closed position by the lip 15 of the activating door 8. Accordingly, when the activating trap door 8 is released from its “floor” position and drops into its open position, the forward edge of the idler door is no longer supported by the lip 15, allowing the idler door 7 to also drop into an open position by pivoting about its pivot points 14. When both trap doors open, the feed that is supported by those doors drops through the chute formed by the open trap doors below and into the trough 4.

Each activating trap door 8 in the feed modules and the trap door 9 in the top of the trough is retained in its closed or “floor” position by reciprocally movable trigger rods 30 and 31 that are slidably mounted on the underside of the activating trap door 8 and the single trap door 9. The proximal ends of the rods 30 and 31 are attached to the remote ends of a centrally pivoted lever 35. One end of the pivoted lever is also connected to a linearly slidable plunger 36 of a spring loaded air cylinder 37 or similarly acting electric solenoid. The distal ends of the trigger rods 30 and 31 extend beyond the lateral edges of the trap doors 8 and 9 and are supported by catches. The catches can take several forms but in the preferred embodiment the catches are formed by ledges 41 at the top end of an inwardly embossed portion 42 of the side walls that carry the pivot studs 16. Upon activation, the plunger 36 of the air cylinder 37 is momentarily extended, moving the pivotal lever 35 about its pivot point and withdrawing the ends of both trigger rods 30 and 31 from their supporting positions over the ledges 39. With the trigger rods no longer supporting the activating trap doors 8 and 9, they drop into an open position, carrying with them their respective assembly of rods 30 and 31 and actuating air cylinder 37. Within a few seconds after actuation the air pressure that extends the plunger disappears and pressure exerted on the plunger by a spring within the cylinder 37 attempts to return the rods 30 and 31 to their supporting, or extended positions. However, because the inwardly facing raised portions 42 of the side walls are formed in an arc that follows the track of the rod ends as the trap door opens, the spring biasing force on the rods cannot return them to their extended positions until the door is manually closed and repositioned into its “floor” position. This latching mechanism lends itself to automated operation for release and quick manual reset functioning when the boxes are to be refilled with food.

As previously mentioned, the topmost feed box 15d is not equipped with trap doors. Instead, its top opening receives a tray 50 that accommodates the components that activate the air cylinders. These components do not form part of the present invention in that they are available prior art devices. They include a timer that may be set for scheduled food drops and appropriate valves or relays that communicate air pressure or alternatively, electrical signals, to the activating cylinders 37 on each feed box in sequential order, beginning with the cylinder on the trap door 9 at the entry opening 11 in the top of the trough 4. Hose lines 52 communicate air pressure from a compressor mounted on the tray 50 to the respective actuators 37 on each set of trap doors.

Activation of the trough trap door 9 dispenses the food contained in the lowermost feed box 15a into the chute of the trough. At the next scheduled feeding interval the activating cylinder on the activating trap door 8 of the lowermost box 15a will open, releasing trap door 7 and allowing the food in the next box 15b to be dispensed into the trough. The trap door 9 at the top of the trough, having been previously opened, remains open and provides an unobstructed path for the feed dropping from higher boxes into the trough. The sequence of opening doors on higher feed boxes continues until all of the feed boxes have been emptied. Once emptied the boxes may re refilled by manually closing all of the trap doors and recharging the boxes with new food.

What is claimed is:

1. An animal feeder comprising,
a feed serving trough having sides, a frontal opening, a feed delivery chute having an entry and a trap door disposed at the entry of the chute,
at least one feed retaining module disposed over the entry to the trough chute, said module having an openable top comprising double trap doors,
latching means for maintaining the trough trap door and each respective one of the module traps doors closed; and
linear actuator means operatively connected to each of the latching means for causing the latching means to release and open the trap doors of the trough and the trap doors of the at least one feed retaining module.

2. The feeder of claim 1 where each of the at least one feed retaining modules includes a charging door on at least one of the sides for permitting the box to be loaded with animal feed.

3. The feeder of claim 1 and further including,
means connecting the at least one feed retaining module to the feed serving trough to permit selective orientation of the charging door of the module with respect to the frontal opening of the feed serving trough.

4. The feeder of claim 1 where each of the latching means includes,
catch means carried by at least one side of the at least one feed retaining module, and
at least one elongated reciprocally movable rod disposed underneath one of the trap doors and disposed to engage the catch means.

5. The feeder of claim 4 where the reciprocally movable rod and the actuator means is carried by one of the trap doors.

6. The feeder of claim 4 and further including,
program means to energize the respective actuator means in sequential order starting with the trap door in the trough entry.

7. An automated animal feeder comprising,
a feed serving trough having a frontal opening,
a plurality of stackable feed retaining boxes, each having a plurality of sides and an openable floor comprising first and second trap doors, where each of said boxes includes,
latching means for maintaining the traps doors closed including,
a catch carried by each one of opposing sides of the feed box,
a pair of opposed elongated reciprocally movable rods, each having distal ends and disposed underneath the first trap door where the ends are engagable with the respective catches on opposing sides of the box to hold the trap door in a closed position,
a lip carried by the first trap door and engagable with the second trap door,
a linearly operating actuator interconnected with each of the rods,
programmable energizer means interconnected to the linear actuator of each box for sequentially operating the respective actuators to disengage the ends of the reciprocally movable rods from the catches to release the trap doors and open the floor of the feed retaining box.

8. The animal feeder of claim 7 where each linear actuator includes spring means for biasing the reciprocally movable rods into a position of engagement with the catches.

9. A sequentially operated animal feeder comprising,
a plurality of superimposed feed dispensing modules,
at least one of the modules having at least one door that has an open and closed position where, in the closed position, the at least one door supports the feed,
reciprocally operable latch means carried by the at least one door, and
catch means engageable with the latch means, and
actuator means comprising a linear movable core connected to the latch means for opening the at least one door.
